(19) United States
(12) Patent Application Publication
(10) Pub. No.: US 2008/0147551 A1
(43) Pub. Date: Jun. 19, 2008

(54) System and Method for a SIP Server with Online Charging

(75) Inventor: David Connelly, San Francisco, CA (US)

Correspondence Address: FLIESLER MEYER LLP, 650 CALIFORNIA STREET, 14TH FLOOR, SAN FRANCISCO, CA, 94108, US

(73) Assignee: BEA SYSTEMS, INC., San Jose, CA (US)

(21) Appl. No.: 11/956,066

(22) Filed: Dec. 13, 2007

Related U.S. Application Data
(60) Provisional application No. 60/869,875, filed on Dec. 13, 2006.
(60) Provisional application No. 60/869,877, filed on Dec. 13, 2006.

(51) Int. Cl. G06Q 20/00

(52) U.S. Cl. 705/44; 705/39

(57) ABSTRACT

The SIP server can be comprised of an engine tier that is designed for high throughput processing of SIP communications and a state tier that maintains state information for access by the engine tier. A Java-based online charging application can be deployed on the SIP server and can enable various applications residing thereon to generate and transmit credit authorization requests to an online charging function server in accordance with the Diameter Ro protocol. These requests can be based on credit authorization with unit reservation and credit authorization with direct debiting. The session state associated with these requests can be maintained in the state tier of the SIP server which can be queried and accessed by the engine tier. Upon receiving appropriate responses from the OCF server, the SIP server can deliver the services and sessions requested by end users.

### CLAIM OF PRIORITY

The present application claims the benefit of U.S. Provisional Patent Application No. 60/869,875 entitled SYSTEM AND METHOD FOR A SIP SERVER WITH ONLINE CHARGING, by David Connelly et al., filed on Dec. 13, 2006 (Attorney Docket No. BEAS-02177US0), which is incorporated herein by reference in its entirety.

### CROSS REFERENCE TO RELATED APPLICATIONS

The following commonly owned, co-pending United States patents and patent applications, including the present application, are related to each other. Each of the other patents/applications are incorporated by reference herein in their entirety:

U.S. Provisional Patent Application No. 60/869,877, entitled SYSTEM AND METHOD FOR A SIP SERVER WITH OFFLINE CHARGING, by David Connelly, filed on Dec. 13, 2006 (Attorney Docket No. BEAS-02176US0);

U.S. patent application Ser. No. 11/956,036, entitled SYSTEM AND METHOD FOR A SIP SERVER WITH OFFLINE CHARGING, by David Connelly, filed on Dec. 13, 2007 (Attorney Docket No. BEAS-02176US1);

U.S. patent application Ser. No. 11/545,648, entitled SIP SERVER ARCHITECTURE FAULT TOLERANCE AND FAILOVER, by Anno R. Langen, et al., filed on Oct. 10, 2006 (Attorney Docket No. BEAS-02059US1).

U.S. patent application Ser. No. 11/545,671, entitled SIP SERVER ARCHITECTURE FOR IMPROVING LATENCY IN MESSAGE PROCESSING, by Anno R. Langen, et al., filed on Oct. 10, 2006 (Attorney Docket No. BEAS-02059US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to managing telecommunications and more particularly to charging periodic payment services in a telecommunications network environment.

### BACKGROUND

Conventionally, telecommunications and network infrastructure providers have relied on often decades old switching technology to providing routing for network traffic. Businesses and consumers, however, are driving industry transformation by demanding new converged voice, data and video services. The ability to meet these demands often can be limited by existing IT and network infrastructures that are closed, proprietary and too rigid to support these next generation services. As a result, telecommunications companies are transitioning from traditional, circuit-switched Public Switched Telephone Networks (PSTN), the common wired telephone system used around the world to connect any one telephone to another telephone, to Voice Over Internet Protocol (VoIP) networks. VoIP technologies enable voice communication over “vanilla” IP networks, such as the public Internet. Additionally, a steady decline in voice revenues has resulted in heightened competitive pressures as carriers vie to grow data/service revenues and reduce churn through the delivery of these more sophisticated data services. Increased federal regulation, security and privacy issues, as well as newly emerging standards can further compound the pressure.

However, delivering these more sophisticated data services has proved to be more difficult than first imagined. Existing IT and network infrastructures, closed proprietary network-based switching fabrics and the like have proved to be too complex and too rigid to allow the creation and deployment of new service offerings. Furthermore, accounting has become an important issue as service providers usually provide prepaid as well as periodically charged services.

### BRIEF DESCRIPTION OF THE DRAWINGS

FIG. 1 is an exemplary illustration of various components of the SIP Server, in accordance with various embodiments.

FIG. 2 is an illustration of an exemplary use of the SIP Server, in accordance with various embodiments.

FIG. 3 is an exemplary illustration of a tiered architecture of the SIP server deployment, in accordance with various embodiments.

FIG. 4 is an exemplary illustration of the SIP server online charging support, in accordance with various embodiments.

FIG. 5 is an exemplary illustration of the immediate event charging message flow for a SIP server with online charging, in accordance with various embodiments.

FIG. 6 is an exemplary illustration of the event charging with unit reservation (ECUR) for a SIP server with online charging, in accordance with various embodiments.

FIG. 7 is an exemplary illustration of the session charging with unit reservation (SCUR) for a SIP server with online charging, in accordance with various embodiments.

FIG. 8 is an exemplary flow chart diagram of SIP server with offline charging, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device or appliance. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided systems and methods for a SIP server with online charging. In various embodiments, the SIP server can be comprised of an engine tier that is designed for high throughput processing of SIP communications and a state tier that maintains state information for access by the engine tier. A Java-based online charging application can be deployed on the SIP server and can enable various applications residing thereon to generate and transmit credit authorization requests to an online charging function server in accordance with the Diameter Ro protocol. These requests can be based on credit authorization with unit reservation and credit authorization with direct debiting. The session state associated with these requests can be maintained in the state tier of the SIP server which can be queried and accessed by the engine tier. Upon receiving appropriate responses from the OCF server, the SIP server can deliver the services and sessions requested by end users.

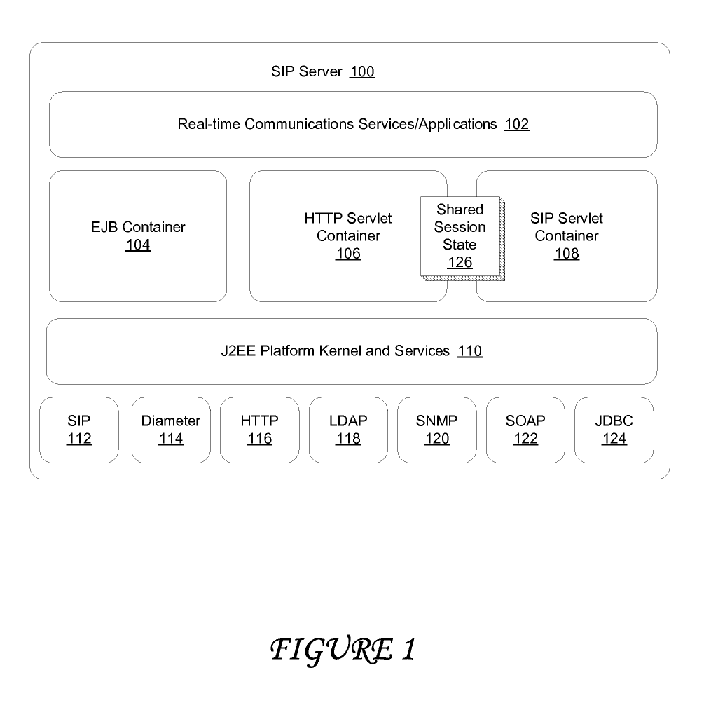

FIG. 1 is an exemplary illustration of various components of the SIP Server, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

In the embodiment illustrated, the SIP Server 100 is a carrier-class Java Enterprise Edition (J2EE) application server that has been extended with support for the Session Initiation Protocol (SIP) and other operational enhancements that allow it to meet the demanding requirements of next-generation internet protocol (IP) based communications networks. The SIP Server can be used to create, deploy and manage various real-time communications services and applications 102 by telecom operators who wish to provide mobile and fixed multimedia services. As with any Java application server, the SIP server can take advantage of the J2EE Platform Kernel and Services 110 in order to compile, execute and optimize the performance of various programs and applications. In one embodiment, the SIP server 100 is also extended with support for a multitude of standards and protocols such as SIP 112, Diameter 114, Hyper Text Transfer Protocol (HTTP) 116, Lightweight Directory Access Protocol (LDAP) 118, Simple Network Management Protocol (SNMP) 120, Simple Object Access Protocol (SOAP) 122, Java Database Connectivity (JDBC) 124, and others.

As stated previously, the SIP Server 100 is enabled to support session initiation protocol (SIP). SIP is a protocol used primarily for creating and terminating sessions with one or more participants, such as setting up or tearing down voice or video calls. SIP is described in more detail in RFC 3261 of the IETF SIP Working Group, which is incorporated herein by reference.

The SIP protocol specification defines different types of high level SIP roles, namely user agents (UA) which include UA clients, UA servers, and Back-to-Back user agents (B2BUA). The SIP protocol also defines the roles of Proxies, Registrars and Redirect Servers. Accordingly, the SIP Servlet API of the SIP server 100 allows any of these roles to be coded as a SIP Servlet Application. Furthermore, because SIP is an extensible protocol, the API is also designed to allow developers to easily extend functionality. This can be accomplished by dividing up the SIP processing between the container functions and the applications. Most of the base protocol can be performed by the container, leaving the higher level tasks for the applications to perform. This division of processing can lead to a great amount of flexibility to the SIP Servlet API.

As further illustrated in FIG. 1, the SIP Server 100 can include an Enterprise Java Bean (EJB) container 104, an HTTP Servlet container 106 and a SIP Servlet container 108. Each of these containers can provide an environment that supports the execution of applications developed using its corresponding technology. For example, the EJB container 104 manages enterprise beans contained within it, which in turn provide the business logic for a J2EE application. This management can encompass services such as registering, creating and destroying objects and their instances, providing remote interfaces to objects, managing the state of objects, maintaining security, and coordinating distributed transactions. Similarly, the HTTP container 106 and the SIP Servlet container 108 can be responsible for managing HTTP and SIP servlets respectively.

The SIP stack of the SIP Server 100 can be fully integrated into the SIP Servlet container 108 and is more powerful and easier to use than a traditional protocol stack. For example the higher level abstraction of the SIP Servlet API can free the developer from the mechanics of handling of transaction timers, syntactic evaluation of received requests, generation of non application-related responses, generation of fully formed SIP requests from request objects (which may involve correct preparation of system headers and generation of syntactically correct SIP messages) and handling of lower-layer transport protocols such as Transport Control Protocol (TCP), User Datagram Protocol (UDP) and Stream Control Transmission Protocol (SCTP).

In one embodiment, the Servlet container can provide a Shared Session Context 126 and session application programming interface (API) in order to maintain awareness of the state of the larger converged SIP and HTTP application session. There are many use cases where a converged application, using both SIP and HTTP functions, is desirable. Some examples of these applications include conferencing and click-to-call applications, as well as Presence and User Agent Configuration Management applications. The converged applications can also use other protocols (e.g. Diameter) to perform more advanced functions such as modifying subscriber profile data. Furthermore, the container can provider a whole host of other services including distributing request and response objects to components in a structured way as well as managing the end-to-end object lifecycle, including resource, transaction and session state management.

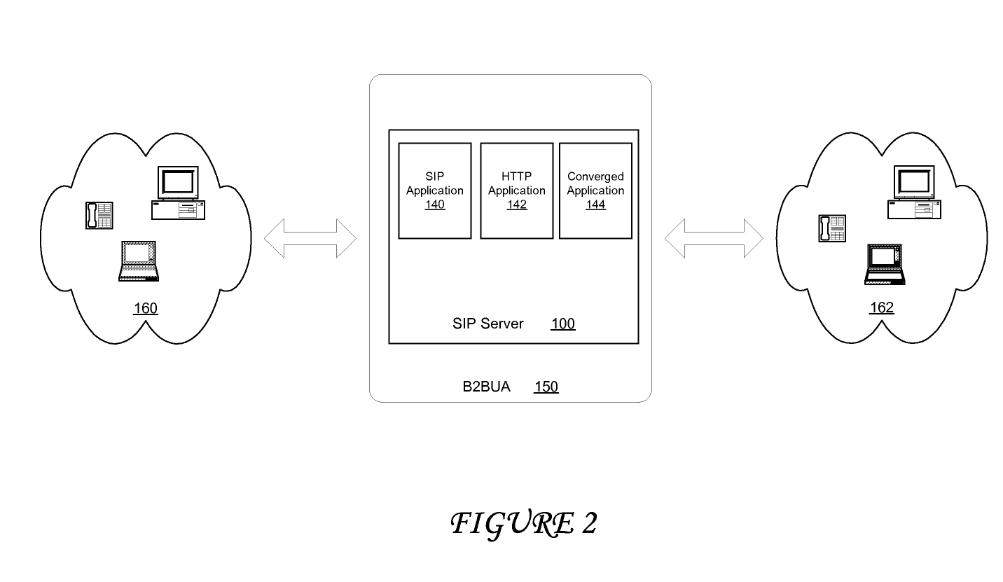

FIG. 2 is an illustration of an exemplary use of the SIP Server, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

In the embodiment illustrated, the SIP server 100, along with the various applications hosted thereon (e.g. 140, 142 and 144), can be used as a back-to-back user agent (B2BUA) 150 in a typical telecommunications environment. A B2BUA can take the place of an intermediary between communications by user agents 160, 162, which may include various cellular phones, wireless devices, laptops, computers, applications, and other components capable of communicating with one another electronically. The B2BUA 150 can provide multiple advantages, such as controlling the flow of communication between user agents, enabling different types of user agents to communicate with one another (e.g. a web application can communicate with a cellular phone), as well as various security advantages. As one illustration, the user agents can transmit to the SIP server instead of communicating directly to each other and thus malicious users can be prevented from sending spam and viruses, hacking into other user agent devices, and otherwise compromising security. It should be noted that the SIP Server 100 need not necessarily take the role of a B2BUA as illustrated in FIG. 2, but can also be used as a proxy, a redirect server, or some other role defined by the SIP protocol.

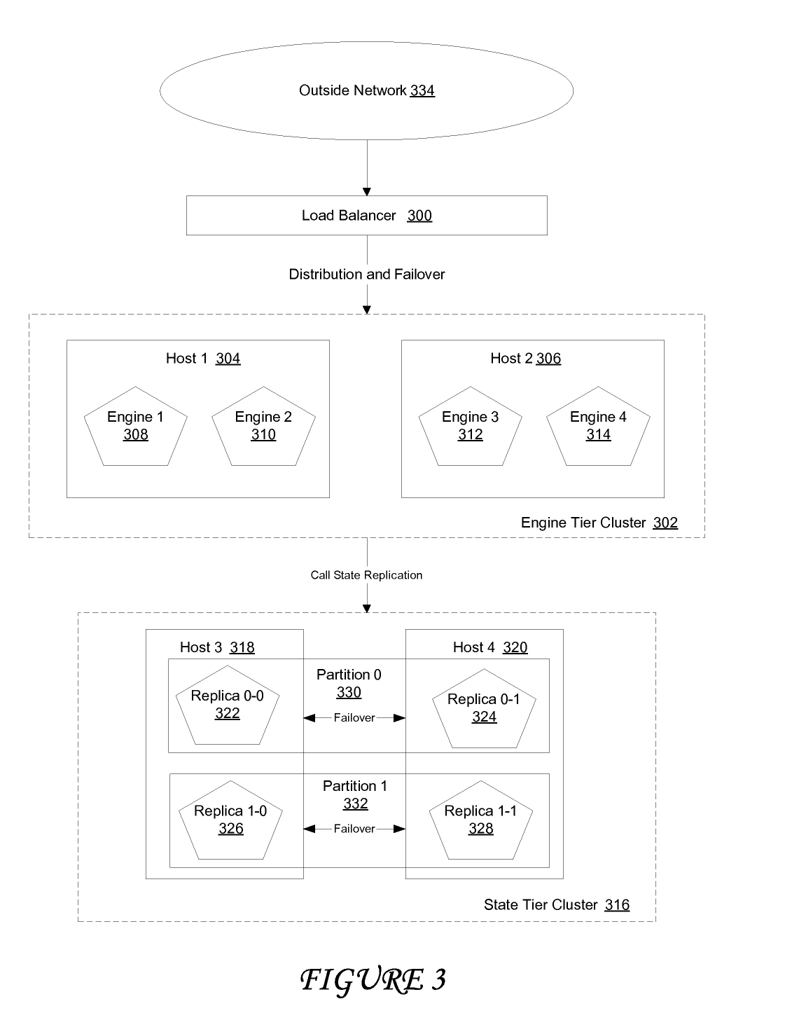

FIG. 3 is an exemplary illustration of a tiered architecture of the SIP server deployment, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

As illustrated, various messages, such as phone call requests or other transfers of data associated with the SIP protocol, can come into the cluster from the internet (such as over VoIP), phone, or some other type of outside network 334. This message can be received and handled by a load balancer 300 which can be responsible distributing message traffic across the engines (i.e. engine 1 308, engine 2 310, engine 3 312 and engine 4 314) in the cluster which handle the processing of the message traffic. The load balancer can be a standard load balancing appliance hardware device and it is not necessary that it be SIP aware; there is no requirement that the load balancer support affinity between the engines and SIP dialogs or transactions. Alternatively, the load balancer can be implemented as software that distributes the messages to the various engines. In the various embodiments, the primary goal of the load balancer 300 can be to provide a single public address that distributes incoming SIP requests to available servers in the SIP server engine tier cluster 302. Such distribution of requests can ensure that the SIP server engines are fully utilized. The load balancer 300 can also be used for performing maintenance activities such as upgrading individual servers or applications without disrupting existing SIP clients.

In the embodiment illustrated, the SIP server can provide a two-tier cluster architecture model to handle the incoming messages. In this model, a stateless engine tier cluster 302 can process all signaling traffic and can also replicate transaction and session state to the state tier cluster 316 which in turn can be divided into multiple partitions. Each partition can consist of any number of nodes (replicas) distributed across any number of hosts such as host 3 318 and host 4 320 which can be implemented as computers linked in a cluster type network environment. For example, partition 0 330 can include state replica 0-0 322 and a state replica 0-1 324 which can maintain copies of the call state information of the partition. The state tier cluster 316 can be an n-way peer-replicated Random Access Memory (RAM) store that maintains various data objects which can be accessed by the engine nodes in the engine tier. In this manner, engines can be provided a dual advantage of faster access to the data objects than retrieving data from a database while at the same time, engines can be freed up from having to store the data onto the engine tier itself. This type of separation can offer various performance improvements. The state tier can also function as a lock manager where call state access follows a simple library book model, (i.e. a call state can be checked out by one SIP engine at a time).

On the other hand, the engine tier cluster 302 can be implemented as a cluster of SIP server instances that hosts the SIP servlets which provide various features to SIP clients. In one embodiment, the engine tier is stateless, meaning that the SIP session state information is not persisted in the engine tier, but is obtained by querying the state tier cluster 316 which can in turn provide replication and failover services for SIP session data.

In various embodiments, the Java Virtual Machine (JVM) garbage collection algorithms can slow down the throughput processing and cause latency when removing stateful long-lived objects from memory. These stateful objects can be thought of as being more global (e.g. referenced by various threads and entities) than other localized stateless objects and as such, the garbage collector would typically stop all thread execution in order to clean them up. In some cases, this can introduce latency since the execution of various threads needs to be halted for a period of time while the garbage collector removes the unused stateful objects. While in typical web server environments this processing pause may be tolerated, the SIP server environment is generally highly sensitive to any latency and as such, this form of garbage collection pausing can be undesirable.

As such, the call state, which may include such stateful objects, can be maintained in memory on the state tier of the SIP server deployment. The engine tier, on the other hand, can be generally stateless so as not to become significantly affected by the various JVM garbage collection and heap clearing processes. Thus, the primary goal of the engine tier 302 can be to provide maximum throughput combined with low response time to SIP clients. As the number of calls or their duration increases, more server instances can be added to the engine tier to manage the additional load. It should be noted however, that although the engine tier may include many such server instances, it can be managed as a single, logical entity. For example, the SIP servlets can be deployed uniformly to all server instances by targeting the cluster itself and the load balancer need not maintain affinity between SIP clients and individual servers in the engine tier.

In various embodiments, the state tier cluster 316 can be implemented as a cluster of SIP server instances that provides a high-performance, highly-available, in-memory store for maintaining and retrieving session state data for SIP servlets. This session data may be required by SIP applications in the SIP server engine tier 302 in order to process incoming messages. Within the state tier 316, session data can be managed in one or more partitions (e.g. partition 0 330 and partition 1 332), where each partition manages a fixed portion of the concurrent call state. For example, in a system that uses two partitions, the first partition 0 330 could manage one half of the concurrent call state (e.g. A-M) and the second partition 1 332 can manage the other half (e.g. N-Z). With three partitions (not shown), each can manage a third of the call state and so on. Additional partitions can be added as needed to manage large number of concurrent calls or incoming messages.

In one embodiment, within each partition, multiple state servers can be added to provide redundancy and failover should the other servers in the partition fail. When multiple servers participate in the same partition, those servers can be referred to as replicas because each server maintains a duplicate copy of the partition's call state. For example, partition 0 330 can maintain its state information in replica 0-0 322 and replica 0-1 324. In some embodiments, the replicas can be distributed over multiple hosts (e.g. host 3 318 and host 4 320) in order to provide host-to-host failover services in cases where a computer crashes. Furthermore, to increase the capacity of the state tier 316, the data can be split evenly across a set of partitions, as previously discussed. The number of replicas in the partition can be called the replication factor, since it determines the level of redundancy and strength of failover that it provides. For example, if one node goes down or becomes disconnected from the network, any available replica can automatically provide call state data to the engine tier.

Replicas can join and leave the associated partition and each replica can serve as exactly one partition at a time. Thus, in one embodiment, the total available call state storage capacity of the cluster is a summation of the capacities of each partition.

In one embodiment, each partition can peer-replicated, meaning that clients perform all operations (reads/writes) to all replicas in the partition (wherein the current set of replicas in the partition is called the partition view). This can provide improved latency advantages over more traditional synchronous “primary-secondary” architecture wherein one store acts as a primary and the other nodes serve as secondaries. Latency is reduced because there is no wait for the second hop of primary-secondary systems. The peer-replicated scheme can provide better host-to-host failover characteristics as well, since there does not need to be change propagation delay.

In one embodiment, the engine nodes 308, 310, 312 and 314 which are distributed over multiple hosts 304, 306, can be responsible for executing the call processing. Each call can have a call state associated with it. This call state can contain various information associated with the call, such as the ids of the caller/callee, where the caller is, what application is running on the callee, as well as any timer objects that may need to fire in order to process the call flow. The state for each call can be contained in the state tier 316. The engine tier 302, on the other hand, could be stateless in order to achieve the maximum performance. In alternative embodiments, the engine tier can have small amounts of state data stored thereon at selected periods of time.

In one embodiment, a typical message processing flow can involve locking/getting the call state, processing the message and putting/unlocking the call state. The operations supported by the replicas for normal operations can include:

lock and get call state—where the engines request state data from the state replicas in the partition and the primary replica locks that state data for processing across all the other replicas in the same partition.

put and unlock call state—where the engines update the state data to the state tier and the data is unlocked for access by other engines.

lock and get call states with expired timers—where session state data that has expired can be retrieved from the state tier.

As previously discussed, the state tier 316 can maintain call state in various data objects residing in the random access memory (RAM) of a computer. This can provide significant access speed advantages to the engine tier 302. The SIP server can also provide a way for efficiently persisting long-lived state information to a database (disk storage) in order to avoid unnecessary consumption of cluster resources. Since RAM is generally significantly more expensive than database memory, it may be desirable to reduce the number of replicas in the state tier 316 by storing at least some of the session state information to the database. In many cases, database access to data is slower than RAM-based replica access. However, because some SIP communications are not as latency-sensitive as others, these communications can be persisted in the database in order to save the amount of random access memory required by the SIP server deployment. For example, a standard telephone call can be viewed as having three stages—a call setup stage, an active call stage and the call teardown stage (hanging up the call). The call setup stage is typically the most latency-sensitive since users tend to expect immediate results from the server after pressing the call button. However, the call teardown stage may not be as sensitive to latency because after the handset disconnects, it may not matter from the user's perspective how long it will take for the server to complete call termination. As such, session state for call termination can be maintained in a database. Similarly, the active call stage may also be not as latency-sensitive as the call setup stage since it mostly involves communication of voice bits between media servers. It should be noted that this example of a telephone call is provided purely for purposes of illustration and is not intended to limit the invention.

Diameter Ro Interface Application for Online Charging

In various embodiments, the SIP server provides a Java-based Diameter Online Charging Application that can be used by applications deployed on the engine nodes to generate charging events based on the Ro interface of Diameter protocol. Online charging, also known as credit-based charging, is used to charge prepaid services. An example of a typical prepaid service is a prepaid calling card for voice or video. Thus, every time that a user makes a phone call, there is usually a credit authorization request issued by a server handling the call to an online charging function (OCF) server.

The Ro protocol specifies how an IP multimedia subsystem (IMS) charging trigger function (CTF) issues offline charging events to a online charging function (OCF). The Diameter protocol is described in further detail in RFC 3588 “Diameter Base Protocol” and RFC 4006 “Diameter Credit-Control Application” available from the Network Working Group, both of which are incorporated in their entirety herein by reference. The Ro protocol is more fully described in TS 32.299 “Diameter Charging Applications” available from the 3^{rd} Generation Partnership Project (3GPP), which is also incorporated herein by reference.

With online charging, there can be two types of authorization models: credit authorization with unit reservation and credit authorization with direct debiting. In either case, the CTF is configured to request credit authorization from the OCF prior to service delivery to the end user. The Diameter Offline Charging Application allows any application deployed on the SIP server to generate charging events based on the Ro protocol. In various embodiments, the Diameter Offline Charging Application is Java based in order to take advantage of interoperability between the various servers and other IMS network elements. An online charging application programming interface (API) is provided in order to enable any deployed application to act as a CTF and issue online charging events.

In various embodiments, credit authorization with unit reservation can be further separated into event charging with unit reservation (ECUR) and session charging with unit reservation (SCUR). Both can be session-based and can involve multiple transactions between the SIP server and the OCF. ECUR involves an interrogation to reserve units before service delivery, followed by an additional interrogation to report used units to the OCF upon service termination. With SCUR, on the other hand, it is also possible to include one or more intermediate interrogations for the SIP server to report currently used units and reserve additional units if required. The session state can be maintained in both the SIP server and the OCF server.

In the case of credit authorization with direct debiting, a single transaction can be involved where the OCF deducts a specific amount from the user's account as soon as the credit authorization is complete. Upon receiving this authorization, the SIP server can proceed with service delivery. In one embodiment, because this is a one time event, no session state needs to be maintained.

The SIP server can also handle the unit and rating determinations. In alternative embodiments, these determinations can be handled by the OCF in order to centralize them. This can be selected within the application by setting appropriate attribute-value pairs (AVPs) in the credit control request sent to the OCF. In various embodiments, unit determination refers to the calculation of the number of non-monetary units such as service units, time and events that can be assigned prior to starting service delivery. Rating, on the other hand, refers to the determination of a price based on the non-monetary units calculated by the unit determination function.

The Diameter online charging application can allow any SIP server application to act as the CTF to issue online charging events to an OCF using the Diameter Ro protocol, as described above. This application can be provided as a separate optional deployment, which, once deployed, is made available to the SIP server applications through a servlet context parameter.

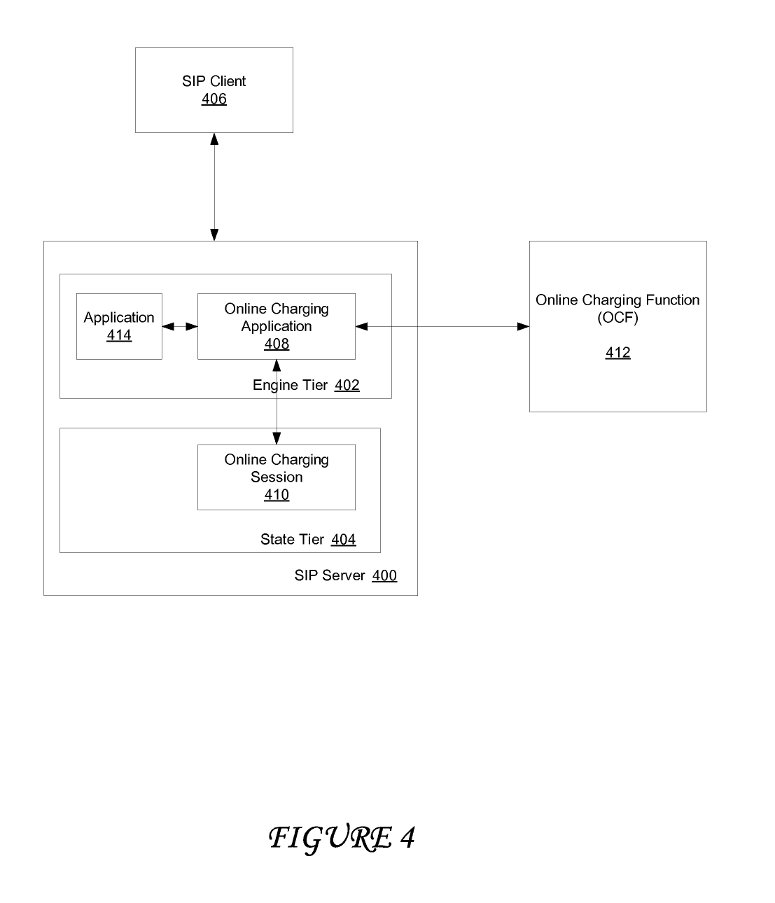

FIG. 4 is an exemplary illustration of the SIP server offline charging support, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

As illustrated, the SIP server 400 can include an engine tier 402 used for high throughput processing of SIP communications and a state tier 404 for storing various call state information. An online charging application 408 deployed in the engine tier can be used by the various SIP server applications 414 in order to generate and send charging events to the online charging function (OCF) server 412. Each instance of the online charging session 410, on the other hand, can be used to actually hold the per-session state unique to each call. In this manner, the applications running on the engine tier 402 can access the necessary state information in the online charging session 410 by querying the state replicas in the state tier 404. Since the accounting session state for offline charging is serializable, it can be stored as a SIP application session attribute.

In one embodiment, all online charging requests use the Diameter Credit Control Request (CCR) message. The credit control request type AVP (which can be set by the application on the CCR message) is used to indicate the type of charging being used. For example, the CC-request-type EVENT_REQUEST can specify immediate event charging. On the other hand, the CC-request-type INITIAL/TERMINATION_REQUEST can specify event charging with unit reservation and INITIAL/UPDATE/TERMINATION_REQUEST can specify session charging with unit reservation, as discussed above. For credit authorization with unit reservation, units are reserved prior to service delivery and committed upon service completion. Units can be reserved with the INITIAL_REQUEST and committed with a TERMINATION_REQUEST. For session charging, units can also be updated with an UPDATE_REQUEST.

In various embodiments, a set of classes added too the SIP server can enable online charging for applications deployed thereon. A non-limiting exemplary listing of such classes is shown below:

| Class | Description | Package |
|---|---|---|
| Ro | Ro constant definitions | com.bea.wcp.diameter.ro |
| RoApplication | Online charging application | com.bea.wcp.diameter.ro |
| RoSession | Online charging session | com.bea.wcp.diameter.ro |
| CCR | Credit control request | com.bea.wcp.diameter.cc |
| CCA | Credit control answer | com.bea.wcp.diameter.cc |
| ASR | Abort session request | com.bea.wcp.diameter |
| ASA | Abort session answer | com.bea.wcp.diameter |
| STR | Session terminate request | com.bea.wcp.diameter |
| STA | Session terminate answer | com.bea.wcp.diameter |

In various embodiments, the RoApplication class is the online charging application which is made available to other SIP server applications through a servlet context parameter. This class is the factory for creating new sessions as well as for sending direct event-based requests which do not require session state. Each instance of the RoApplication can be used by multiple concurrent threads.

The RoSession class, on the other hand, can be used to create new sessions for session based credit authorization. In one embodiment, the RoSession class implements the appropriate state machine depending on the control type (ECUR or SCUR) and is also serializable such that it can be stored as a SIP session attribute, allowing the session to be restored later when needed to terminate the session or update credit authorization. An example of creating a new RoSession for event-based charging and sending a CCR request to start the first interrogation is illustrated below. Note this non-limiting example also saves the RoSession instance for later use, such as when terminating the session after the service has finished.

RoSession session = roApp.createRoSession(Ro.ECUR);
CCR ccr = session.createCCR(Ro.INITIAL_REQUEST);
ccr.send( );
sipSession.setAttribute(“RoSession”, session);

In various embodiments, the CCR class represents the Diameter Credit Control Request message and is used to send credit control requests to the OCF. The RoApplication can be used directly to create CCR messages for immediate event charging. For unit reservation charging, on the other hand, an instance of the RoSession class is used to create new CCR requests. Upon creating the CCR, the application using the online charging application can set the service specific AVPs, as needed, before the request is sent out. Various setter and getter methods, such as setSubscriptionld( ), setServiceldentifier( ), setRequestedServiceUnit( ), and others can be provided in the CCR and CCA answers for setting the appropriate AVPs. In various embodiments, some AVPs can be included in each new request for the session, and thus it is possible to set all of these AVPs on the session itself. Subsequently, custom AVPs can be added to the CCR request message with a method such as addAvpo before the message is sent.

In one embodiment, the sending of CCR requests is synchronous such that the application thread is blocked until the corresponding CCA is received by the SIP server from the OCF server. This may cause the number of threads in the transport thread queue to reach a high number. In that case, a thread pool implementation can dynamically create new threads as needed. It should be noted, however, that the synchronous implementation is not intended to limit the present invention and various asynchronous solutions can also be adapted.

In one embodiment, the call state can also remain locked until the CCA is received. Because the service delivery usually does not proceed until the credit authorization has completed, this locking should not have much effect on the application itself. Once the CCA is received, the application can examine the result code AVP in the CCA error responses from the OCF to detect the cause of any failure and to take appropriate action. A protocol timer object Timer Tx can specify how long the client will wait for the OCF to respond to a credit authorization request. For example, Timer Tx may be set to a default value of 10 seconds and may be overridden by setting a parameter on the RoApplication configuration. The timer is started when a CCR request is sent out to the OCF and then reset once a corresponding CCA is received. If Timer Tx expires before CCA is received, a call to waitForAnswer can immediately return null to indicate that the request has timed out. Application can then take appropriate action according to Credit-Control-Failure-Handling AVP specified in the request, such as terminating the session.

In various embodiments, the Diameter session state is stored as part of the call state maintained in the state tier of the SIP server deployment. The RoApplication can automatically link a Diameter session to its corresponding call state. This can be accomplished by special encoding of the call state identifier within the Diameter Session-Id AVP. The call state id can be extracted from the Diameter session id and then be used to find the correct call state for handling the message. The call state can then be locked and the request be delivered to the appropriate RoSession.

Detection of duplicate online charging messages can also be provided to the SIP server. For example, both the Session-Id and the CC-Request-Number AVPs can be inspected to detect duplicate messages. In some embodiments, this may require additional state to maintained in the Ro session state in order to absorb duplicate messages.

In various embodiments, the SIP server can be configured to handle the Abort-Session-Request and the Re-Auth-Request received from the online charging system (OCS). In case of an abort session request, the SIP server can look up the appropriate RoSession in the call state maintained in the state tier and remove it. In case of a credit reauthorization request, the online charging application can invoke a session listener on the applications corresponding to the RoSession object. The applications can then respond to the OCS with an appropriate reauthorization answer and initiate credit reauthorization to the CTF by sending a CCR message with the CC-Request-Type AVP set to the value UPDATE_REQUEST.

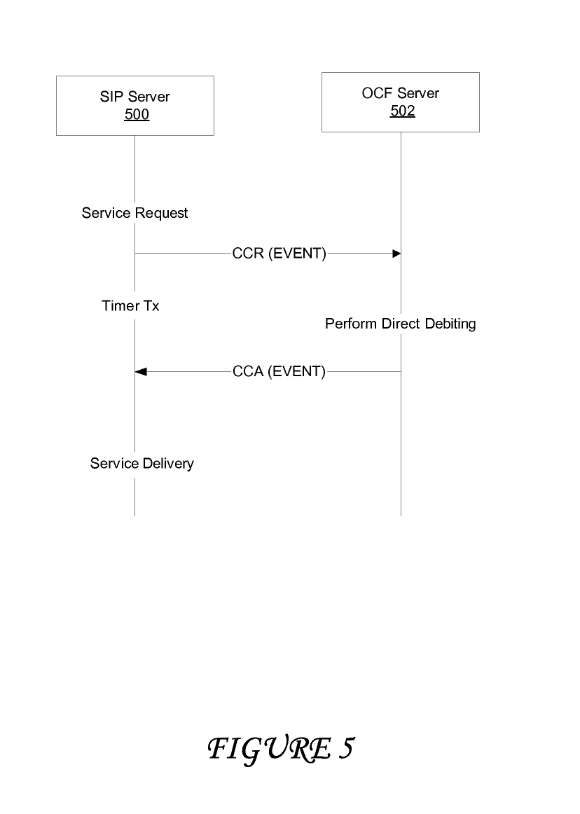

FIG. 5 is an exemplary illustration of the immediate event charging message flow for a SIP server with online charging, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

In this figure time can be viewed as flowing downward in a vertical fashion. As shown, the SIP server 500, acting as the CTF, can begin by receiving a service request from a SIP client such as an end user. In response, the SIP server can generate a CCR of type EVENT and transmit this message to the OCF server 502. Upon sending the CCR, the SIP server can also enable and start a timer object used to indicate a timed out OCF in case it should not respond. Upon receiving said CCR, the OCF can perform appropriate direct debiting of the end user's account and in response transmit a CCA of type EVENT back to the SIP server. At this point, the SIP server can deliver a set of services to the SIP client, having received appropriate authorization from the OCF server. For immediate event charging, there is no need that the application itself maintain an instance of the RoSession. Thus, a session object can be created internally within the SIP server which can be destroyed immediately after receiving the authorization response from the OCF server. An illustrative and non-limiting example of how the RoApplication could be used to directly send IEC requests is shown below.

CCR ccr = roApp.createEventCCR( );
ccr.setRequestedServiceUnit(...);
ccr.send( );
CCA cca = ccr.waitForAnswer( );

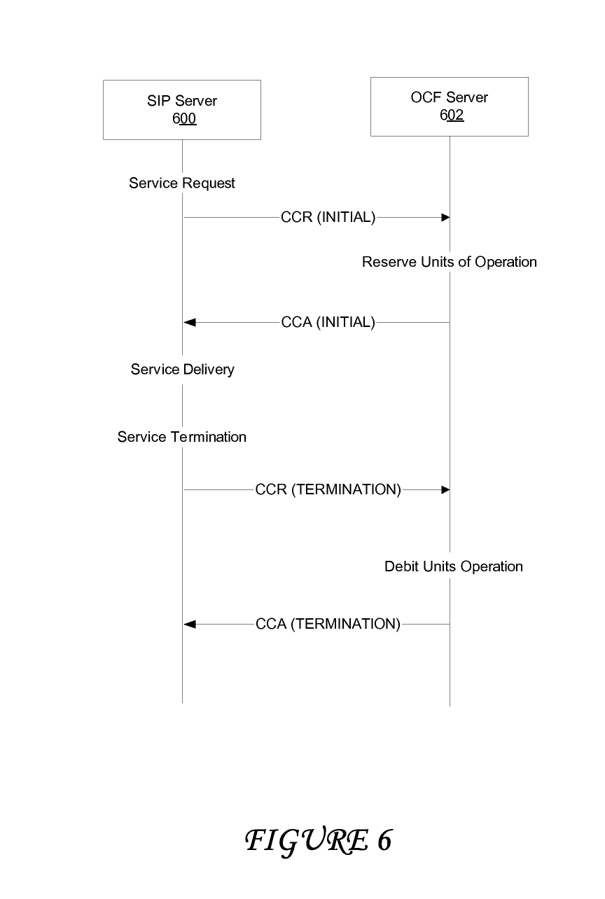

FIG. 6 is an exemplary illustration of the event charging with unit reservation (ECUR) for a SIP server with online charging, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As illustrated, the flow can begin by the SIP server 600 receiving a service request from a SIP client. The SIP server can then generate a CCR of type INITIAL and transmit it to the OCF which can reserve the appropriate service units upon receiving the request. After reserving the service units, the OCF server 602 can respond by sending a CCA of type INITIAL and service delivery can be provided by the SIP server. After completion of the services, the SIP server can send a CCR of type TERMINATION whereupon, the OCF server can debit the previously reserved units from the end user's account. In one embodiment, the OCF server commits the reserved units upon receiving the TERMINATION request message. Subsequently, the OCF server can respond by sending the appropriate CCA of type TERMINATION. Throughout this exchanging of messages, the session state for the online charging application can be maintained in the state tier of the SIP server such that it can be locked and unlocked similarly to the call state data. In one embodiment, the session state is stored as part of the call state data in the state replicas.

Some illustrative and non-limiting examples of how the RoSession could be used to reserve units before service delivery, reusing it upon termination of the service and using it again later to report used service units to the account are shown below.

//reserving units before service delivery, then
//debiting the units upon termination of service
RoSession session = roApp.createRoSession(Ro.ECUR);
session.setSubscriptionId(...);
session.setServiceIdentifier(...);
CCR ccr = session.createCCR(Ro.INITIAL_REQUEST);
ccr.setRequestedServiceUnit(...);
ccr.send( );
CCA cca = ccr.waitForAnswer( );
sipSession.setAttribute(“RoSession”, session);
AvpList granted = cca.getGrantedServiceUnit( );

//reporting used service units to the account
RoSession session = (RoSession)
session.getAttribute(“RoSession”);
CCR ccr = session.createCCR(Ro.TERMINATION_REQUEST);
ccr.setUsedServiceUnit(...)
ccr.send( );
CCA cca = ccr.waitForAnswer( );
AvpList cost = cca.getCostInformation( );

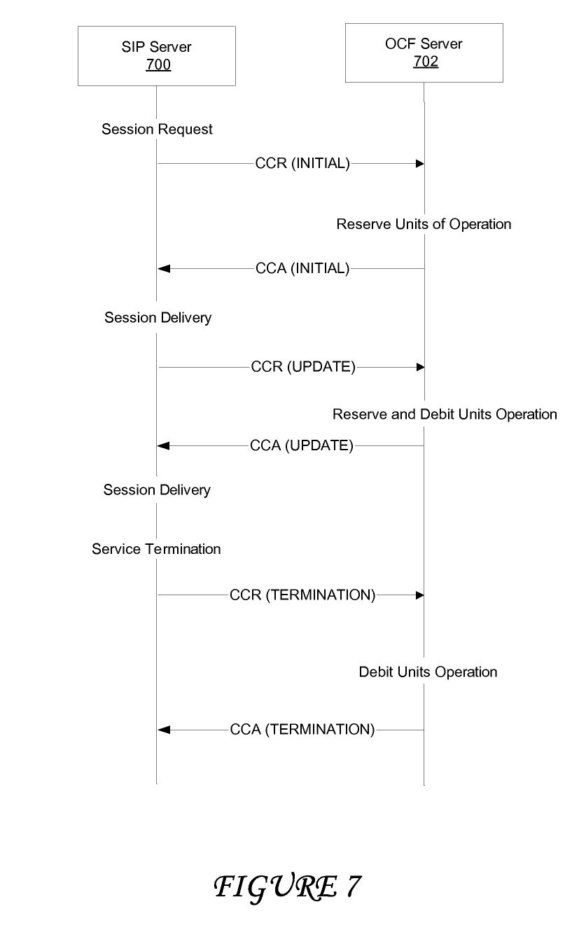

FIG. 7 is an exemplary illustration of the session charging with unit reservation (SCUR) for a SIP server with online charging, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As shown, the SIP server 700 can receive a session request and thereupon generate and transmit a credit control request of type INITIAL to the OCF server 702. The OCF can in turn perform an appropriate operation to reserve the service units and respond with a credit control answer of type INITIAL. Upon receiving this answer, the SIP Server, acting as the CTF, can deliver the session requested by the end user. Throughout the life of the session, the SIP server can periodically send CCR UPDATE requests in order to report the currently used service units and reserve any additional units if required. Upon receiving each CCR UPDATE, the OCF can perform appropriate operations to reserve and debit the service units and respond with a credit control answer UPDATE.

Upon completion of the services, the session is terminated and the SIP server sends a CCR TERMINATION request where the OCF server performs final debit operation and returns a CCA TERMINATION response. In various embodiments, the session state data is maintained within the state tier of the SIP server, while the online charging operation is deployed on the engine tier. Some illustrative and non-limiting examples of starting the service session, reporting usage and reserving additional units and terminating the session are shown below.

//starting the service session and reserving units
RoSession session = roApp.createRoSession(Ro.SCUR);
session.setSubscriptionId(...);
session.setServiceIdentifier(...);
CCR ccr = session.createCCR(Ro.INITIAL_REQUEST);
ccr.setRequestedServiceUnit(...);
ccr.send( );
CCA cca = ccr.waitForAnswer( );
sipSession.setAttribute(“RoSession”, session);

//reporting usage and reserving additional units while
//session is in progress
RoSession session = (RoSession)
sipSession.getAttribute(“RoSession”);
CCR ccr = session.createCCR(Ro.UPDATE_REQUEST);
ccr.setUsedServiceUnit(...);
ccr.setRequestedServiceUnit(...);
ccr.send( );
CCA cca = ccr.waitForAnswer( );

//report final usage upon termination of session
RoSession session = (RoSession)
sipSession.getAttribute(“RoSession”);
CCR ccr = session.createCCR(Ro.TERMINATION_REQUEST);
ccr.setUsedServiceUnit(...);
ccr.send( );
CCA cca = ccr.waitForAnswer( );
sipSession.removeAttribute(“RoSession”);

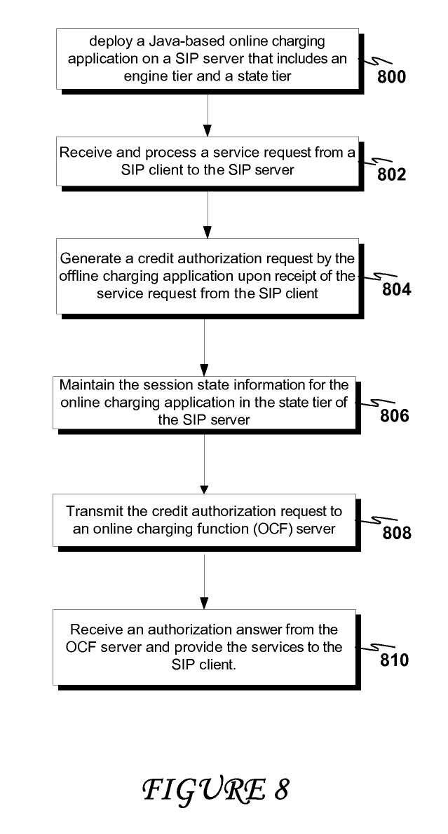

FIG. 8 is an exemplary flow chart diagram of SIP server with offline charging, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As shown in step 800, a Java based online charging application can be deployed to the SIP server. The SIP server deployment can be comprised of an engine tier that processes various SIP transactions, as well as a state tier that maintains the call state data associated with those transactions. In step 802, the SIP server can receive a service request from an end user or a SIP client. The online charging application deployed in the engine tier can then generate a credit authorization request, as shown in step 804. The session state data for the authorization request can be maintained in the state tier, as illustrated in step 806. For example, the session state can be stored as part of the call state maintained in the state tier.

In step 808, the credit authorization request can be transmitted to the online charging function server which can perform the appropriate reserve and debit operations, as previously discussed. In step 810, the online charging application can receive an authorization answer from the OCF and the SIP server can subsequently deliver the various services to the end user. It should also be noted that communication between the online charging application and the OCF can also include various other types of requests and answers, such as EVENT, INITIAL, UPDATE, TERMINATE and other types of messaging. In this manner, the online charging application can enable various SIP server applications to generate charging events to an OCF server.

Various embodiments previously described include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments and containers, as well as user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A computer implemented method for providing online charging, said method comprising:
deploying a Java-based online charging application on a session initiation protocol (SIP) server, said SIP server including an engine tier that processes SIP communications and a state tier that maintains call state data associated with said SIP communications;
receiving a service request from a SIP client to said SIP server;
generating a credit authorization request by said offline charging application upon receipt of said service request from the SIP client;
maintaining online charging session state data in the state tier on said SIP server;
transmitting said credit authorization request to an online charging function (OCF) server by said offline charging application;
receiving an authorization answer from said OCF server; and
delivering, by said SIP server, a set of services to said SIP client upon receiving said authorization answer.

2. The method according to claim 1 wherein transmitting said credit authorization request to the OCF further includes:
setting an attribute value pair (AVP) on said authorization request wherein said AVP indicates service-specific information to the OCF.

3. The method according to claim 1 wherein maintaining the online charging session state data in the state tier on said SIP server further includes:
automatically linking, by the online charging application, said online charging session to a corresponding call state by encoding a call state identifier within the online charging session identifier attribute value pair (AVP).

4. The method according to claim 1 wherein the online charging session state data is stored as part of the call state in the state tier of said SIP server.

5. The method according to claim 1 wherein said engine tier includes a plurality of engine node servers that receive and process SIP communications distributed from a load balancer.

6. The method according to claim 1 wherein said state tier stores state information in a set of partitions, each partition including one or more state replica nodes that maintain a copy of the state for the partition.

7. The method according to claim 1 further comprising:
transmitting by said online charging application, a service termination request to the OCF after completing the set of services; and
receiving a service termination answer from said OCF wherein the OCF commits any units reserved upon receiving said service termination request.

8. The method according to claim 1 wherein transmitting said credit authorization request to the OCF server further includes:
starting a timer object that indicates a timed out credit authorization request upon not receiving a response from said OCF within a specified period of time.

9. A system for providing online charging to a session initiation protocol (SIP) server, said system comprising:
a session initiation protocol (SIP) server adapted to process one or more SIP communications, said SIP server including a Java-based online charging application deployed thereon; and
a SIP client adapted to send said SIP communications to said SIP server;
wherein said online charging application is configured to receive a service request from said SIP client, generate at least one credit control request (CCR) message and transmit said CCR message to an online charging function (OCF) server prior to delivering a set of services to said SIP client by the SIP server.

10. The system according to claim 9 wherein said SIP server further includes:
an engine tier that processes said SIP communications, said engine tier having said online charging application deployed thereon; and
a state tier that maintains call state data associated with said SIP communications, said call state data including session state of said online charging application.

11. The system according to claim 10 wherein the online charging application is further configured to:
automatically link said session state for the online charging application to a corresponding call state stored in the state tier by encoding a call state identifier within the online charging session identifier attribute value pair (AVP).

12. The system according to claim 9 wherein said offline charging application is further configured to:
receive at least one credit authorization from the OCF server prior and deliver the set of services to said SIP client upon receiving said credit authorization.

13. The system according to claim 9 wherein said online charging application is further configured to:
transmit a service termination request to the OCF after completing the set of services and receive a service termination answer from said OCF wherein the OCF commits any units reserved upon receiving said service termination request.

14. The system according to claim 9 wherein said online charging application is further configured to:
send one or more credit update requests to the OCF wherein said OCF commits any previously reserved service units and reserves a new set of service units upon receiving said credit update requests.

15. The system according to claim 9 further comprising:
a timer object residing on the SIP server, said timer object configured to indicate that a credit authorization request has timed out not having received a response from said OCF.

16. A computer-readable medium having instructions stored thereon which when executed by one or more processors cause a system to:
deploy a Java-based online charging application on a session initiation protocol (SIP) server, said SIP server including an engine tier that processes SIP communications and a state tier that maintains call state data associated with said SIP communications;
receive a service request from a SIP client to said SIP server;
generate a credit authorization request by said offline charging application upon receipt of said service request from the SIP client;
maintain online charging session state data in the state tier on said SIP server;
transmit said credit authorization request to an online charging function (OCF) server by said offline charging application;
receive an authorization answer from said OCF server; and
deliver, by said SIP server, a set of services to said SIP client upon receiving said authorization answer.
